(19) United States
(12) Patent Application Publication
(10) Pub. No.: US 2017/0213265 A1
(43) Pub. Date: Jul. 27, 2017

(54) ELECTRONIC DISTRIBUTION SYSTEM AND METHOD FOR COLLECTIBLE ITEMS

(71) Applicant: The Upper Deck Company, Carlsbad, CA (US)

(72) Inventors: Jason Masherah, Carlsbad, CA (US); Benjamin Swiderski, Carlsbad, CA (US)

(73) Assignee: The Upper Deck Company

(21) Appl. No.: 15/416,992

(22) Filed: Jan. 26, 2017

Related U.S. Application Data
(60) Provisional application No. 62/287,151, filed on Jan. 26, 2016.

(51) Int. Cl. G06Q 30/06; H04N 1/00

(52) U.S. Cl. CPC G06Q 30/0601; H04N 1/00018

(57) ABSTRACT

A electronic distribution system (10) for use by one or more consumers (20) comprises a first provider (12) that manufactures a plurality of physical trading cards (22A); a second provider (14) that scans the plurality of physical trading cards (22A) to generate a plurality of corresponding electronic trading cards (22B); a third provider (16) that collates the plurality of corresponding electronic trading cards (22B) into a plurality of digital containers (24); and a system website and application (18) where the one or more consumers (20) can purchase one or more of the plurality of corresponding electronic trading cards (22B). A first consumer (20) can purchase one or more of the plurality of corresponding electronic trading cards (22B), and can selectively receive one or more of the plurality of physical trading cards (22A) that are associated with the corresponding electronic trading cards (22B) that the first consumer (20) purchased.

### RELATED APPLICATION

This application claims priority on U.S. Provisional Application Ser. No. 62/287,151, filed on Jan. 26, 2016 and entitled “ELECTRONIC DISTRIBUTION SYSTEM AND METHOD FOR TRADING CARDS”. As far as permitted, the contents of U.S. Provisional Application Ser. No. 62/287,151 are incorporated herein by reference.

### BACKGROUND

All around the world there are various types of collectible items that people like to collect and trade. For example, trading cards are a popular way to collect images and information about athletes, movies, television, events, historical and public figures, and celebrities. The traditional method of adding cards to one's collection is to drive to a store and purchase one or more packs of trading cards. A pack of trading cards in this context includes one or more trading cards. Subsequently, after opening the one or more packs of trading cards, the collector can then store, trade or sell any of the trading cards that they have acquired.

### SUMMARY

The present invention is directed toward an electronic distribution system for use by one or more consumers. In various embodiments, the electronic distribution system includes a first provider that manufactures a plurality of physical trading cards; a second provider that scans the plurality of physical trading cards to generate a plurality of corresponding electronic trading cards; and a system website and application where the one or more consumers can purchase one or more of the plurality of corresponding electronic trading cards.

In some embodiments, each of the plurality of physical trading cards is scanned to generate one of the plurality of corresponding electronic trading cards. Additionally, each of the plurality of physical trading cards and its corresponding electronic trading card can be assigned a common ID code.

The electronic distribution system can further include a third provider that generates a plurality of digital-only trading cards. In some embodiments, the one or more consumers can purchase one or more digital-only trading cards of the plurality of digital-only trading cards on the system website and application. Additionally, the one or more consumers can then redeem any of the one or more digital-only trading cards for one or more physical trading cards.

Additionally, in certain embodiments, the electronic distribution system further includes a fourth provider that collates the plurality of corresponding electronic trading cards and the plurality of digital-only trading cards into a plurality of digital containers. The digital containers can include digital packs of trading cards, digital boxes of trading cards, and/or digital cases of trading cards. In some such embodiments, the fourth provider collates the plurality of corresponding electronic trading cards and the plurality of digital-only trading cards based on collation guidelines provided by one of the first provider, the second provider and the third provider.

Further, a first consumer of the one or more consumers can purchase one or more of the plurality of digital containers on the system website and application. In some embodiments, the corresponding electronic trading cards and the digital-only trading cards within each of the plurality of digital containers are not known to the first consumer prior to the first consumer purchasing the one or more of the plurality of digital containers. Alternatively, in other embodiments, when the first consumer purchases a digital box or digital case of trading cards, the first consumer can be guaranteed one or more certain trading cards are contained within the digital box or digital case. The first consumer can then open the one or more of the plurality of digital containers that were purchased by the first consumer such that the corresponding electronic trading cards and the digital-only trading cards within the one or more of the plurality of digital containers are revealed electronically to the first consumer.

In some embodiments, the electronic distribution system can further include a third provider that collates the plurality of corresponding electronic trading cards into a plurality of digital containers. In certain embodiments, the third provider collates the plurality of corresponding electronic trading cards based on collation guidelines provided by one of the first provider and the second provider.

Further, in certain embodiments, a first consumer of the one or more consumers can selectively receive one or more of the plurality of physical trading cards that correspond with the corresponding electronic trading cards that the first consumer purchased from the system website and application. In one such embodiment, the first consumer redeems one of the corresponding electronic trading cards that the first consumer purchased from the system website and application in order to receive the physical trading card that is associated with the one of the corresponding electronic trading cards. In another embodiment, the first consumer may pay a fee to receive the one or more of the plurality of physical trading cards. In such embodiment, the first consumer may retain the corresponding electronic trading cards that the first consumer purchased from the system website in addition to receiving the one or more of the plurality of physical trading cards.

Still further, in some embodiments, the trading card distribution further includes a third provider that manufactures a plurality of physical collectible items (e.g., collectible coins, comic books, etc.); and a further provider that scans the plurality of physical collectible items to generate a plurality of corresponding electronic collectible items. In some such embodiments, the one or more consumers can purchase one or more of the plurality of corresponding electronic collectible items from the system website and application.

The present invention is further directed toward an electronic distribution system for use by a first consumer, the electronic distribution system including a system website and application where the first consumer can purchase one or more of a plurality of electronic trading cards; and wherein the first consumer can selectively receive one or more of a plurality of physical trading cards that are associated with the electronic trading cards that the first consumer purchased from the system website and application.

Additionally, the present invention is further directed toward an electronic distribution system for use by one or more consumers, the electronic distribution system comprising one or more parties to perform the following (A) a first provider that manufactures a plurality of physical collectible items; (B) a second provider that scans the plurality of physical collectible items to generate a plurality of corresponding electronic collectible items, each of the plurality of physical collectible items being scanned to generate one of the plurality of corresponding electronic collectible items; (C) a third provider that generates a plurality of digital-only collectible items; (D) a fourth provider that collates the plurality of corresponding electronic collectible items and the plurality of digital-only collectible items into a plurality of digital containers; and (E) a system website and application where a first consumer of the one or more consumers can purchase one or more of the plurality of digital containers, the corresponding electronic collectible items and the digital-only collectible items within each of the one or more of the plurality of digital containers not being known to the first consumer prior to the first consumer purchasing the one or more of the plurality of digital containers; wherein the first consumer can open the one or more of the plurality of digital containers that were purchased by the first consumer such that the corresponding electronic collectible items and the digital-only collectible items within the one or more of the plurality of digital containers are revealed electronically to the first consumer; and wherein the first consumer can one of (i) redeem one of the corresponding electronic collectible items within the one or more of the plurality of digital containers, and (ii) pay a fee, to selectively receive one or more of the plurality of physical collectible items that correspond with the corresponding electronic collectible items within the one or more of the plurality of digital containers that the first consumer purchased from the system website and application.

Further, the present invention is also directed toward a method for distributing, collecting and trading electronic trading cards.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an embodiment of an electronic distribution system having features of the present invention; and

FIG. 2 is a flowchart illustrating an embodiment of the operation of the electronic distribution system illustrated in FIG. 1.

### DESCRIPTION

Embodiments of the present invention are described herein in the context of an electronic distribution system and method for collectible items, e.g., trading cards, collectible coins, comic books, memorabilia, or any other suitable items that people like to collect and trade. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

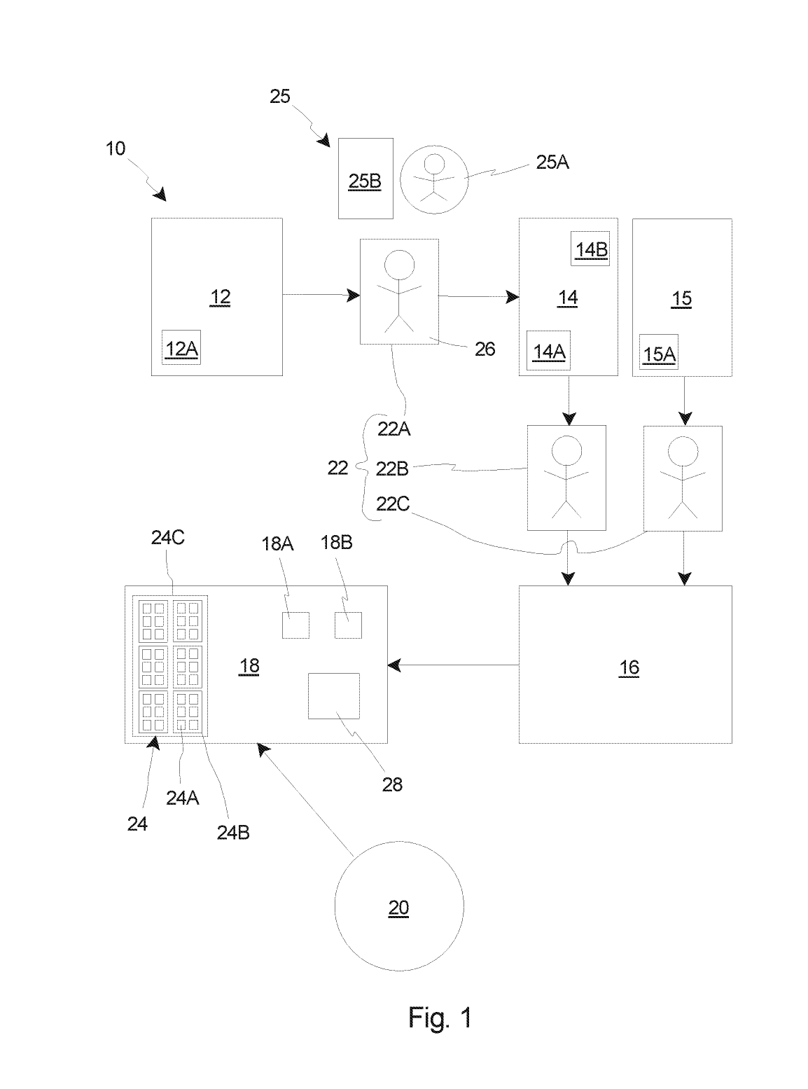

FIG. 1 is a simplified schematic illustration of an embodiment of an electronic distribution system 10 (also referred to herein simply as a “distribution system”) having features of the present invention. As provided herein, the distribution system 10 can be use by consumers for collecting and trading any suitable types of collectible items. For example, the distribution system 10 can be utilized by consumers for the collection and trading of trading cards. Additionally and/or alternatively, the distribution system 10 can be utilized by consumers for the collection and trading of other collectible items, such as collectible coins, memorabilia, comic books, and the like. As such, although the description provided herein primarily focuses on the electronic distribution of trading cards, it should be appreciated that the distribution system 10 can be equally applicable to the electronic distribution of any suitable collectible items. Thus, any specific mention of “trading cards” can equally be replaced by a more general reference to “collectible items” without impacting the intended scope and breadth of the present invention. Further, it should also be appreciated that the distribution system 10 can be utilized for the electronic distribution of any combination of suitable collectible items.

The design of the distribution system 10 can be varied. In certain embodiments, as illustrated in FIG. 1, the distribution system 10 includes an operating party or entity, i.e. an operator 12 (illustrated simply as a box), a scanning party or entity, i.e. a scanner 14 (illustrated simply as a box), a generating party or entity, i.e. a generator 15 (illustrated simply as a box), a maintaining party or entity, i.e. a maintainer 16 (illustrated simply as a box), a system website and/or application 18 (also referred to herein simply as a “website/app”), and one or more consumers 20 (only one is illustrated simply as a circle in FIG. 1). Alternatively, the distribution system 10 can include more components or fewer components than those specifically illustrated and described in FIG. 1. For example, in one non-exclusive alternative embodiment, the distribution system 10 can be designed without the generator 15.

As described in detail herein, the operator 12, the scanner 14, the generator 15 and the maintainer 16 consist of individual entities or parties that cooperate to provide a plurality of trading cards 22 (or other suitable collectible items) to be offered for sale on the website/app 18 to the one or more consumers 20. As such, the operator 12, the scanner 14, the generator 15 and the maintainer 16 can sometimes be referred to individually and/or collectively as the “providers”. It should be appreciated that the various functions and roles of any of the providers, i.e. the operator 12, the scanner 14, the generator 15 and the maintainer 16, can be combined, shared and/or divided up in any suitable manner, and can be performed by the same party or multiple parties. Stated in another manner, any of the functions or roles that are described herein as to be accomplished by any one of the providers 12, 14, 15, 16 can be performed by any of the other providers 12, 14, 15, 16. Additionally, any such functions or roles can be combined in any suitable manner, such that the general function of providing the plurality of trading cards 22 (or other suitable collectible items) to be offered for sale on the website/app 18 to the one or more consumers 20 can be accomplished by a single provider or more than one provider 12, 14, 15, 16. Thus, the recitation herein of any specific roles or functions being performed by any one or more of the providers 12, 14, 15, 16 is not intended to be limiting in any manner. It should be understood that the terms “providers”, “entities” and “parties” can be used interchangeably. Additionally, any reference herein to a “first provider”, a “second provider”, etc. does not necessarily indicate that the providers are distinct from one another, as multiple providers as so identified can actually consist of a single provider (or entity or party).

As utilized herein, the term “trading card” means a card containing pictures, materials, autographs, designs, and/or other unique elements, which is intended to be collected and traded. A trading card is usually part of a set of somewhat similar cards packaged in a card pack or other container. However, a card pack can include a single or multiple trading cards.

As an overview, in certain embodiments, the distribution system 10 is configured to provide a unique means for distributing physical trading cards 22A, corresponding electronic (digital) trading cards 22B, and/or digital-only trading cards 22C to the one or more consumers 20. As described in detail herein, the system and method for distributing trading cards 22 provides benefits such as ease for the consumer 20 of purchasing containers 24 (e.g., packs, boxes and/or cases) of trading cards 22 from the website/app 18 in order to develop their personal collection of trading cards 22; ease for the consumer 20 in storing their trading cards 22; and ease for the consumer 20 of trading, buying, or selling individual trading cards 22 and/or containers 24 of trading cards 22.

Further, the system and method for distributing trading cards 22 described herein can also provide benefits for the operator 12 such as enabling rapid adjustment to product mix, product content and design, and product pricing based on consumer feedback, purchasing activity, and other market trends.

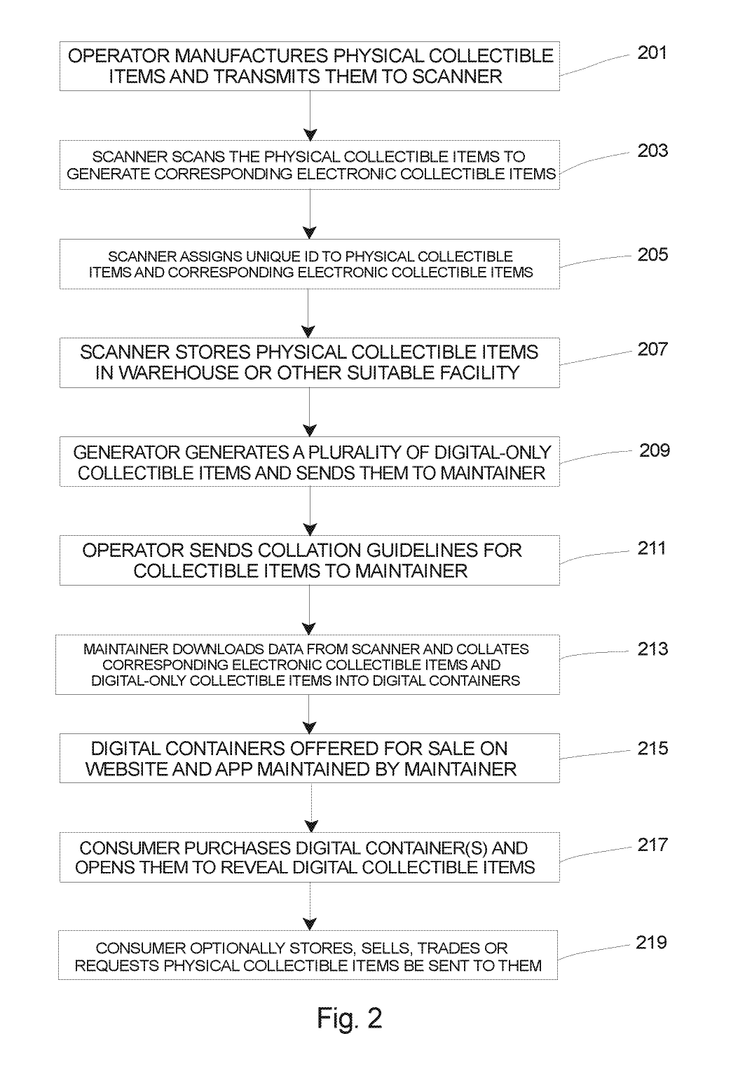

Additionally and/or alternatively, as noted above, in some embodiments, the distribution system 10, i.e. as described herein below in relation to FIG. 2, can be similarly utilized for the distribution of products other than trading cards 22. For example, in some such embodiments, the distribution system 10, e.g., the operator 12, the scanner 14, the generator 15 and the maintainer 16, can also perform similar functions with respect to a plurality of other collectible items 25, such as collectible coins 25A, comic books 25B, etc., in addition to performing all such functions with respect to the trading cards 22. As such, although the present description primarily focuses on an electronic distribution system and method for trading cards, it should be appreciated that a comparable electronic distribution system and method can be utilized with collectible coins 25A, comic books 25B or other memorabilia and/or products that may be desired to be collected by the one or more consumers 20. Additionally, it should also be understood that the other collectible items 25, such as collectible coins 25A, comic books 25B, and the like, can be packaged separately from the trading cards 22 or can be packaged individually, collectively, or with one or more trading cards 22. Additionally, with regard to the potential application of the distribution system 10 to other collectible items 25, such as collectible coins, memorabilia, comic books, etc., it should be understood that any other such collectible items 25 can also come in packages or containers that contain single or multiple collectible items 25.

As utilized herein, the term “collectible coin” means a coin containing pictures, materials, designs, and/or other unique elements, which is intended to be collected and traded. Alternatively, the present invention can be used for other items, comic books, or memorabilia such as, without limitation, stamps.

FIG. 2 is a flowchart illustrating an embodiment of the operation of the electronic distribution system 10 illustrated in FIG. 1. One or more of the operations can be performed by one or more processors for a computer-implemented system. Further, the digital trading cards and other information can be stored in one or more non-transitory computer readable storage systems that are accessed by the one or more processors.

FIG. 2 more explicitly illustrates an embodiment of the general operations of the distribution system 10 illustrated in FIG. 1. It should be appreciated that the various steps described herein can be modified as necessary in the process of operating the electronic distribution system 10. Additionally, it should also be appreciated that in certain applications the order of the steps can be modified, certain steps can be omitted, additional steps can be added, and/or certain steps can be combined without limiting the intended scope and breadth of the present invention.

In step 201, the operator 12 (illustrated in FIG. 1) manufactures and/or creates (e.g., prints on a digital printer 12A (illustrated as a box in FIG. 1)) a plurality of the physical trading cards 22A (illustrated in FIG. 1). Subsequently, the operator 12 can transmit, e.g., bulk ship, the physical trading cards 22A to a scanner 14 (illustrated in FIG. 1). It should be appreciated that in an embodiment wherein the operator 12 and the scanner 14 are in actuality the same provider (or party or entity), there would be no need to transmit the physical trading cards 22A to the scanner 14.

The design, size and shape of the physical trading cards 22A can be varied to suit the desired design requirements of the physical trading cards 22A. Additionally, the operator 12 can manufacture any desired number of physical trading cards 22A. Further, the physical trading cards 22A can be manufactured to have varying rarity and value in order to enhance the collection experience for the one or more consumers 20. Still further, in embodiments that include memorabilia and other collectible items 25, such as collectible coins 25A or comic books 25B, it should be understood that the collectible coins 25A and comic books 25B can have any suitable design, size and shape, and can be manufactured from any suitable materials.

In some embodiments, the physical trading cards 22A are generally rectangular-shaped and have a length of between 2.0 and 6.0 inches, a width of between approximately 1.5 and 4.0 inches, and a thickness of between approximately 0.05 and 0.50 inches. For example, the physical trading cards 22A can have the same approximate cross-sectional area of a standard trading card having a length of approximately 3.5 inches, a width of approximately 2.5 inches, and a thickness of between approximately 0.0625 and 0.25 inches. Alternatively, the physical trading cards 22A can have a different shape and/or have a different size. In certain alternative embodiments, for example, the physical trading cards 22A can be generally square-shaped, circle-shaped, oval-shaped, triangle-shaped, hexagon-shaped, or some other shape, and/or the physical trading cards 22A can have dimensions that are greater than or less than those provided above.

Additionally, the physical trading cards 22A can each include a card body 26 (illustrated in FIG. 1) that can be made from card stock. Alternatively, the card body 26 can be made from a material other than card stock. For example, the range of substrates utilized to form the card body 26 includes cardboard, paper, wood, plastic and metal.

The physical trading cards 22A typically contain photos of events, locations, sports team indicia, animals, entertainment characters and worlds, religious subjects, and third parties such as athletes, public figures, or celebrities. Further and for example, some physical trading cards 22A can feature signatures of the athlete or celebrity who is depicted in the photo. Additionally and/or alternatively, some physical trading cards 22A can feature pieces of jerseys that players have worn in games or other related memorabilia, or other materials worn by an actor or actress or used as a prop in or featured on a movie or television show. Additionally and/or alternatively, some physical trading cards 22A can feature other unique materials corresponding to content featured on the physical trading card.

Moreover, it should be appreciated that the physical trading cards 22A, being physical entities, can include certain unique characteristics, such as multiple colors on a jersey insert on a card, multiple colors on a patch card, damaged corners on the physical trading card 22A, or any other unique characteristics. It should further be appreciated that although not all such unique characteristics of the physical trading cards 22A are necessarily desirable to the consumers 20, such characteristics provide unique character that is not typically found in electronic trading cards.

In step 203, the scanner 14 scans the physical trading cards 22A, e.g., with a digital scanner 14B (illustrated as a box in FIG. 1) in order to generate a plurality of corresponding electronic (digital) trading cards 22B (illustrated in FIG. 1). It should be appreciated that, in certain embodiments, there is a direct one-to-one relationship between the physical trading cards 22A and the corresponding electronic trading cards 22B, such that each individual physical trading card 22A has one corresponding electronic trading card 22B.

Additionally, it should further be appreciated that because the corresponding electronic trading cards 22B are images that are generated from direct scans of the physical trading cards 22A, the consumer 20 (illustrated in FIG. 1) who ultimately receives the corresponding electronic trading card 22B is able to fully view and understand the unique characteristics of the physical trading card 22A and the corresponding electronic trading card 22B. For example, as noted above, the consumer 20 can view and fully understand such unique characteristics as multiple colors on a jersey insert on a card, multiple colors on a patch card, damaged corners on the card, etc.

In step 205, the scanner 14 assigns unique ID tags to each physical trading card 22A that has been scanned to generate the corresponding electronic trading cards 22B. The scanner 14 further assigns the same unique ID tag for each physical trading card 22A to the corresponding electronic trading card 22B to which the physical trading card 22A specifically corresponds. Thus, in this embodiment, at this point, each physical trading card 22A has a corresponding electronic trading card 22B that is tagged with the same unique ID code. Alternatively, the corresponding electronic trading cards 22B can be assigned an ID tag that is associated with, but is different than, the unique ID tag that has been assigned to the physical trading card 22A.

In step 207, the scanner 14 stores the physical trading cards 22A in a system warehouse 14A (illustrated in FIG. 1). As noted above, the physical trading cards 22A that are stored in the system warehouse 14A will each include the unique ID tag that matches that of the corresponding electronic trading card 22B that was generated from the scanning of the physical trading card 22A. Alternatively, the physical trading cards 22A may be stored at another suitable facility.

In step 209, the generator 15 (illustrated in FIG. 1) generates a plurality of digital-only trading cards 22C (illustrated in FIG. 1), e.g., with a digital printing device 15A (illustrated as a box in FIG. 1). Each of the plurality of digital-only trading cards 22C is also tagged with its own unique ID code. It should be understood that with the digital-only trading cards 22C, there will be no corresponding physical trading cards that have the same unique ID code. The generator 15 can then transmit the plurality of digital-only trading cards 22C to the maintainer 16 (illustrated in FIG. 1). Alternatively, the maintainer 16 can otherwise access and/or receive the plurality of digital-only trading cards 22C.

In some embodiments, the digital-only trading cards 22C can have the same approximate size and shape as the physical trading cards 22A and thus the corresponding electronic trading cards 22B. Alternatively, the digital-only trading cards 22C can have a size and shape that is different than that of the physical trading cards 22A and/or the corresponding electronic trading cards 22B.

In step 211, the operator 12 sends collation guidelines for the trading cards 22 (illustrated in FIG. 1) to the maintainer 16. As provided herein, the maintainer 16 maintains the website/app 18 (illustrated in FIG. 1) on which the trading cards 22 will ultimately be sold to the one or more consumers 20. The collation guidelines can be established to combine trading cards 22 in any desired manner. For example, trading cards 22 of varying design, rarity and value can be collated in any suitable manner according to the established collation guidelines. Additionally, the collation guidelines can specify that the plurality of corresponding electronic trading cards 22B and the plurality of digital-only trading cards 22C be combined in any suitable manner.

In step 213, the maintainer 16 downloads the card data for each of the corresponding electronic trading cards 22B from the scanner 14. It should be appreciated that the maintainer 16 can otherwise access, store, and/or receive the card data for each of the corresponding electronic trading cards 22B in another suitable manner.

Subsequently, the maintainer 16 uses the collation guidelines that were received from the operator 12 and collates the corresponding electronic trading cards 22B and the digital-only trading cards 22C into digital packs 24A (illustrated in FIG. 1) of trading cards. It should be understood that any of the digital packs 24A of trading cards can include a single trading card 22 or more than one trading card 22. Additionally, the digital packs 24A of trading cards can further be combined to form digital boxes 24B (illustrated in FIG. 1) of trading cards that each contain a plurality of digital packs 24A of trading cards. Further, the digital boxes 24B of trading cards can then be combined to form digital cases 24C (illustrated in FIG. 1) of trading cards that each contain a plurality of digital boxes 24B of trading cards.

It should be appreciated that, in some embodiments, the collation guidelines may specify that at least some of the digital packs 24A (or boxes 24B or cases 24C) of trading cards contain both one or more corresponding electronic trading cards 22B (which have associated physical trading cards 22A) and one or more digital-only trading cards 22C (which do not have associated physical trading cards). Further, the collation guidelines may additionally and/or alternatively specify that certain digital packs 24A (or boxes 24B or cases 24C) of trading cards contain only one or the other of corresponding electronic trading cards 22B and digital-only trading cards 22C.

In some embodiments, each of the plurality of digital packs 24A of trading cards can be created based on the collation guidelines and then sealed so that the contents are hidden. Thus, in various embodiments, each of the plurality of digital packs 24A of trading cards includes a plurality of trading cards 22. Additionally, a plurality of sealed digital packs 24A of trading cards can be placed in digital boxes 24B, which are then further sealed. Thus, each of the plurality of digital boxes 24B of trading cards includes a plurality of digital packs 24A of trading cards. The sealed digital boxes 24B of trading cards can then be placed in digital cases 24C, which are also sealed. Thus, each of the plurality of digital cases 24C of trading cards includes a plurality of digital boxes 24B of trading cards.

Further, in certain embodiments, because the contents of the digital box 24B and digital case 24C can follow the same collation guidelines as traditional physical boxes and cases, these collation guidelines can dictate that certain cards are guaranteed within a sealed digital box 24B or digital case 24C. Thus, if the consumer 20 elects to purchase, and open in its entirety, a sealed digital box 24B or digital case 24C, the consumer 20 can be guaranteed certain cards as outlined in the collation guidelines of the specific product. Other products may be packaged individually, or collectively in different quantities and formats.

It should be understood that, as used herein, the digital packs 24A of trading cards, the digital boxes 24B of trading cards, and/or the digital cases 24C of trading cards can be referred to individually and/or collectively as digital containers 24 (illustrated in FIG. 1) of trading cards.

In step 215, once the corresponding electronic trading cards 22B and the digital-only trading cards 22C are collated into digital containers 24 of trading cards as accomplished in step 213; the corresponding electronic trading cards 22B and the digital-only trading cards 22C, as arranged into such digital containers 24, are offered for sale on the website/app 18 to the one or more consumers 20.

As utilized and described herein, the website/app 18 can include one or more processors 18A (illustrated as a box in FIG. 1) or circuits that enable the various functions and procedures described in detail herein. Additionally, the website/app 18 can further include a storage device 18B (illustrated as a box in FIG. 1) for storing any relevant information for purposes of carrying out various steps in the process described herein.

In step 217, each of the one or more consumers 20 can purchase one or more of the digital containers 24 of trading cards. More specifically, the consumers 20 can purchase one or more sealed digital packs 24A of trading cards, which can be purchased either individually via packs, boxes or cases. Additionally, as noted above, any of the packs can be configured to contain a single trading card (or other collectible item) or multiple trading cards (or other collectible items). The contents of the purchased digital containers 24 of trading cards are then assigned to an appropriate user account that is set up for each of the one or more consumers 20.

In various embodiments, as consumers 20 purchase the digital packs 24A, digital boxes 24B, and digital cases 24C of trading cards, the packs are not randomly chosen from the entire inventory of digital containers 24 of trading cards. Instead, if a consumer 20 purchases a pack, a sealed case is opened, and a sealed box within the case is opened, and a pack is removed from that box and sold to the consumer 20. Once this opened box is exhausted, a new sealed box from this case is opened, and loose packs are sold from this box. Accordingly, if a sealed box is purchased, and if an opened case has sealed boxes left in it, a box is taken from this inventory and sold. If no loose sealed boxes remain, another sealed case is opened and a sealed box is selected from it and sold to the consumer 20. Lastly, if a consumer 20 selects to purchase a case, a sealed case is selected from the inventory and sold to the consumer.

The consumer 20, if they purchase a box or case, can open the box or case by opening individual packs within the box or case. In certain embodiments, the consumer 20 has the option to open a portion of the box or case, and place the remaining sealed packs or boxes in their inventory to be opened, sold, or traded at a later date. Additionally, when a consumer 20 purchases a digital pack 24A, a digital box 24B, or a digital case 24C of trading cards 22, the consumer 20 does not have to open the purchased digital pack 24A, digital box 24B, or digital case 24C immediately. Upon purchase, the contents of the digital pack/box/case is determined and locked in (i.e. the contents of the digital pack/box/case are determined not by when the consumer 20 opens it, but rather when the purchase is made). These digital packs/boxes/cases are then placed in the consumer's inventory. The consumer 20 then has the choice to open none, a portion, or all, of their purchased products at any time. The consumer has the ability to not only hold the unopened purchased product in his or her inventory, but to also trade or sell immediately, or at a later date, the purchased, unopened products.

Additionally and/or alternatively, in some embodiments, if a consumer 20 purchases and chooses to open a sealed digital box 24B or digital case 24C of trading cards 22, the distribution system 10 can provide a button where all of the digital packs 24A in the digital box 24B or digital case 24C can be opened with a single click, and the entire contents of the digital box 24B or digital case 24C are displayed for the consumer 20. This button can also be clicked during the pack opening experience as long as the entire digital box 24B or digital case 24C has not be opened in its entirety. If the consumer 20 elects this option, this button functions to open all remaining digital packs 24A in the digital box 24B or digital case 24C with a single click.

As noted, at this point, the consumer 20 can choose to open their digital container(s) 24 of trading cards, and the contents of the digital container 24 are then revealed to the consumer 20 so that the consumer 20 now knows what trading cards 22 he or she has purchased. The individual corresponding electronic trading cards 22B and/or digital-only trading cards 22C from the digital container 24 are also then made visible in the appropriate user account for the consumer 20 that purchased that particular digital container 24. In such method, similar to the most traditional method where packs of physical trading cards are purchased from a store, the consumer 20 can experience an immediate rush of excitement as soon as they purchase the digital container 24 of corresponding electronic trading cards 22B and/or digital-only trading cards 22C, as they are able to immediately find out what trading cards 22 are in their digital container 24 as soon as they buy it.

In summary, the electronic distribution system 10 as described in detail herein enables the one or more consumers 20 to purchase and then open up all or a portion of digital containers 24 of corresponding electronic trading cards 22B and/or digital-only trading cards 22C at any time of the day and on any suitable electronic device, e.g., on their phone, tablet, or computer.

In step 219, the consumer 20 then has various options as far as what they wish to do with the various corresponding electronic trading cards 22B and/or digital-only trading cards 22C within their collection, i.e. within their user account. For example, the consumer 20 can opt to have their corresponding electronic trading cards 22B and/or digital-only trading cards 22C stored on the website/app 18 as a storage solution for their collection.

Alternatively, the consumer 20 can communicate with other consumers 20 and attempt to sell or trade any of their corresponding electronic trading cards 22B and/or digital-only trading cards 22C to any of the other consumers 20. The consumer 20 can attempt to sell or trade any of their corresponding electronic trading cards 22B and/or digital-only trading cards 22C through any suitable method in order to achieve a more rewarding collection experience. For example, the consumer 20 can transfer their corresponding electronic trading cards 22B and/or digital-only trading cards 22C to the website/app 18 and then can sell or trade their corresponding electronic trading cards 22B and/or digital-only trading cards 22C to any other consumer 20. In one non-exclusive embodiment, the website/app 18 can include a marketplace 28 (illustrated simply as a box in FIG. 1) that is configured to encourage and enable the quick and easy selling and trading of any of the corresponding electronic trading cards 22B and/or digital-only trading cards 22C. Consumers 20 can also create want lists that show what trading cards 22 they may want to buy or trade for, and the card marketplace 28 can be further configured to help find such trading cards 22 in the collections of other consumers 20. Additionally, once the marketplace 28 has been implemented on the website/app 18, the consumers 20 will also have the ability to sell or trade any sealed digital packs 24A, digital boxes 24B or digital cases 24C they have in their inventory to any other consumers 20.

Still alternatively, the consumer 20 can choose to purchase one or more of the physical trading cards 22A that correspond to their corresponding electronic trading cards 22B. This option can entail the consumer 20 placing a specific order as to which physical trading cards 22A they would like to have shipped to them. In certain alternative embodiments, the option to purchase and receive the physical trading cards 22A can require a “cost” to be paid by the consumer 20. Such “costs” can include the payment of a fee, the redeeming (deletion) of the corresponding electronic trading card(s) 22B, and/or other suitable “costs”.

In some such embodiments, the order that is placed by the consumer 20 is transmitted to the scanner 14 that has been storing the corresponding physical trading cards 22A in the system warehouse 14A. Using the unique ID tags that are associated with each of the physical trading cards 22A and the corresponding electronic trading cards, the scanner 14 can locate the appropriate physical trading cards 22A in the system warehouse 14A. The scanner 14 then ships the appropriate requested physical trading cards 22A to the consumer 20 by any suitable shipping method, which can be selected by the consumer 20. It should be appreciated that once the consumer 20 receives their physical trading cards 22A, the consumer 20 is free to store, sell or trade any or all of their physical trading cards 22A as they see fit.

As noted above, the digital-only trading cards 22C are digital only and exist only in the digital space (i.e. there is no directly corresponding physical trading card), and thus cannot be redeemed for a precise physical counterpart. However, for some electronic trading cards and/or some digital-only trading cards 22C, if a certain number of electronic trading cards and/or digital-only trading cards 22C, e.g., one or more, are collected by a consumer 20, said consumer 20 has the option to combine these electronic trading cards and/or digital-only trading cards 22C into (i) a digital card that does have a physical counterpart, which can then be mailed to the consumer 20 if they make such a request, and/or (ii) some other prize or reward (e.g., another physical card). The number of digital-only trading cards 22C necessary to convert to a digital card with a physical counterpart can be varied. As non-exclusive examples, 2, 5, 8, 10, or 15 of the digital-only cards 22C are required for conversion. In one embodiment, each of the digital-only cards 22C must have the same content. In another embodiment, different content digital-only cards 22C can be combined for the conversion.

In summary, as provided herein, the distribution system 10 is uniquely configured such that any of the one or more consumers 20 can purchase a digital container 24 of corresponding electronic trading cards 22B and/or digital-only trading cards 22C, with the contents of the digital container 24 being assigned to a user account owned by the consumer 20. Once the consumer 20 chooses to open their digital container 24 of corresponding electronic trading cards 22B and/or digital-only trading cards 22C, the contents of the digital container 24, i.e. the specific corresponding electronic trading cards 22B and/or digital-only trading cards 22C within the digital container 24, are revealed to the consumer 20. The consumer 20 can then choose to store, sell or trade any or all of their corresponding electronic trading cards 22B and/or digital-only trading cards 22C; or the consumer 20 can have one or more of the physical trading cards 22A associated with the corresponding electronic trading cards 22B shipped to them, where the consumer can then decide to store, sell or trade any or all of their physical trading cards 22A.

Moreover, with the present distribution system 10, the consumers 20 can receive such benefits as (i) purchasing and opening digital containers 24 of trading cards anytime they want, without waiting for the mail or driving to the hobby shop; (ii) redeeming corresponding electronic trading cards 22B for their physical trading card 22A counterparts and have the physical trading card(s) 22A mailed to them at any time; (iii) storing their virtual collection of corresponding electronic trading cards 22B and/or digital-only trading cards 22C online; (iv) easily trading their corresponding electronic trading cards 22B and/or digital-only trading cards 22C amongst other consumers 20 using the distribution system 10, e.g., using the website/app 18; (v) electronically displaying their collection; (vi) communicating with other consumers 20 about the distribution system 10, trading cards 22, the subject matter contained on or within the trading cards 22, and their individual trading card collections, and/or (vii) earning rewards for collecting in any suitable system or competition. The distribution system 10 can further alert consumers 20 on their phone, computer and/or tablet when new products are made available for sale, when limited time sales start, when a consumer 20 receives a trade offer on one of their trading cards 22, and/or when trading cards 22 a consumer 20 is looking for shows up in the card marketplace 28.

Additionally, from the standpoint of the operator 12, the distribution system 10 offers various advantages such as enabling the operators 12 to adjust product mixes, pack content, and price points on a daily basis based on consumer feedback and purchasing activity. In particular, instant consumer feedback can be received, which can allow adjusted product mixes to be created in days, not months. The operator 12 can create strategic and targeted sales on select products based on consumer purchasing activity. For example, new content for “in demand” players can be added to packs with just a few days' notice. Further, creativity for trading card designs by the operator 12 may no longer be constrained by physical printing limitations, e.g., with the creation of digital-only trading cards.

Moreover, the distribution system 10 can help to bring in a new generation of collectors, which can be taught how to collect through in-app rewards that encourage collecting, digital-only products with low purchase prices, interactive games involving trading cards, etc. For example, lower price points for digital-only products can decrease barriers to entry into the hobby and allow for younger audiences to try out card collecting.

It should be understood that the distribution system 10 described herein can be tailored in any suitable manner to enhance the experience for all consumers 20 as well as the providers 12, 14, 15, 16 within the distribution system 10. For example, the distribution system 10 can be tailored to ensure compatibility across multiple platforms. This can ensure access to the greatest number of collectors and future collectors. Additionally, the distribution system 10 can be designed to incorporate animations and sound effects. Such interactive features can draw the user in and, for example, replicate the physical pack opening experience as closely as possible. Further, certain perks can be provided to the consumers 20, such as, in one non-exclusive example, free digital-only packs of electronic trading cards can be given to consumers 20 on a recurring (e.g., daily) basis. This can be used to create new and free daily content that will bring the consumers 20 back to the website/app 18 on a daily basis. Still further, the use of the website/app 18 can enable consumers 20 to easily create want lists of specific trading cards 22 which they would like to acquire. This enables consumers 20 to know what other consumers 20 are looking for within their collections, which can enhance the trade market and help facilitate trades and allow consumers 20 to complete their collections faster. Yet further, the consumers 20 can participate in various games involving trading cards 22 that can be established on the website/app 18.

It is understood that although a number of different embodiments of the distribution system 10 have been illustrated and described herein, one or more features of any one embodiment can be combined with one or more features of one or more of the other embodiments, provided that such combination satisfies the intent of the present invention.

While a number of exemplary aspects and embodiments of a distribution system 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An electronic distribution system for use by one or more consumers, the electronic distribution system comprising one or more parties to perform the following:
a first provider that manufactures a plurality of physical trading cards;
a second provider that scans the plurality of physical trading cards to generate a plurality of corresponding electronic trading cards; and
a system website and application where the one or more consumers can purchase one or more of the plurality of corresponding electronic trading cards.

2. The electronic distribution system of claim 1 wherein each of the plurality of physical trading cards is scanned to generate one of the plurality of corresponding electronic trading cards.

3. The electronic distribution system of claim 2 wherein each of the plurality of physical trading cards and its corresponding electronic trading card are assigned a common ID code.

4. The electronic distribution system of claim 1 further comprising a third provider that generates a plurality of digital-only trading cards.

5. The electronic distribution system of claim 4 wherein the one or more consumers can purchase one or more digital-only trading cards of the plurality of digital-only trading cards on the system website and application; and wherein the one or more consumers can redeem any of the one or more digital-only trading cards for one or more physical trading cards.

6. The electronic distribution system of claim 4 further comprising a fourth provider that collates the plurality of corresponding electronic trading cards and the plurality of digital-only trading cards into a plurality of digital containers.

7. The electronic distribution system of claim 6 wherein each of the one or more of the plurality of digital containers can be any of a digital pack, a digital box and a digital case.

8. The electronic distribution system of claim 6 wherein a first consumer of the one or more consumers can purchase one or more of the plurality of digital containers on the system website and application; and wherein the corresponding electronic trading cards and the digital-only trading cards within each of the one or more of the plurality of digital containers are not known to the first consumer prior to the first consumer purchasing the one or more of the plurality of digital containers.

9. The electronic distribution system of claim 8 wherein the first consumer can open the one or more of the plurality of digital containers that were purchased by the first consumer such that the corresponding electronic trading cards and the digital-only trading cards within the one or more of the plurality of digital containers are revealed electronically to the first consumer.

10. The electronic distribution system of claim 8 wherein the first consumer can store, trade or sell any of the one or more of the plurality of digital containers on the system website and application without opening the one or more of the plurality of digital containers.

11. The electronic distribution system of claim 1 further comprising a third provider that collates the plurality of corresponding electronic trading cards into a plurality of digital containers.

12. The electronic distribution system of claim 1 wherein a first consumer of the one or more consumers can selectively receive one or more of the plurality of physical trading cards that correspond with the corresponding electronic trading cards that the first consumer purchased from the system website and application; and
wherein the first consumer redeems one of the corresponding electronic trading cards that the first consumer purchased from the system website and application in order to receive the physical trading card that is associated with the one of the corresponding electronic trading cards.

13. The electronic distribution system of claim 1 wherein a first consumer of the one or more consumers can selectively receive one or more of the plurality of physical trading cards that correspond with the corresponding electronic trading cards that the first consumer purchased from the system website and application; and wherein the first consumer pays a fee to receive the one or more of the plurality of physical trading cards; the first consumer retaining the corresponding electronic trading cards that are associated with the one or more of the plurality of physical trading cards.

14. The electronic distribution system of claim 1 further comprising a third provider that manufactures a plurality of physical collectible items; and a fourth provider that scans the plurality of physical collectible items to generate a plurality of corresponding electronic collectible items; and wherein the one or more consumers can purchase one or more of the plurality of corresponding electronic collectible items from the system website and application.

15. An electronic distribution system for use by a first consumer, the electronic distribution system comprising:
a system website and application where the first consumer can purchase one or more of a plurality of electronic trading cards; and
wherein the first consumer can selectively receive one or more of a plurality of physical trading cards that are associated with the electronic trading cards that the first consumer purchased from the system website and application.

16. The electronic distribution system of claim 15 wherein the first consumer redeems one of the electronic trading cards that the first consumer purchased from the system website and application in order to receive the physical trading card that is associated with the one of the electronic trading cards.

17. The electronic distribution system of claim 15 wherein the first consumer pays a fee to receive the one or more of the plurality of physical trading cards; the first consumer retaining the electronic trading cards that correspond with the one or more of the plurality of physical trading cards.

18. The electronic distribution system of claim 15 wherein the plurality of electronic trading cards includes one or more corresponding electronic trading cards that each correspond with one of the plurality of physical trading cards, and one or more digital-only trading cards.

19. The electronic distribution system of claim 15 wherein each of the plurality of electronic trading cards is a corresponding electronic trading card that corresponds with one of the plurality of physical trading cards.

20. An electronic distribution system for use by one or more consumers, the electronic distribution system comprising one or more parties to perform the following:
a first provider that manufactures a plurality of physical collectible items;
a second provider that scans the plurality of physical collectible items to generate a plurality of corresponding electronic collectible items, each of the plurality of physical collectible items being scanned to generate one of the plurality of corresponding electronic collectible items;
a third provider that generates a plurality of digital-only collectible items;
a fourth provider that collates the plurality of corresponding electronic collectible items and the plurality of digital-only collectible items into a plurality of digital containers; and
a system website and application where a first consumer of the one or more consumers can purchase one or more of the plurality of digital containers, the corresponding electronic collectible items and the digital-only collectible items within each of the one or more of the plurality of digital containers not being known to the first consumer prior to the first consumer purchasing the one or more of the plurality of digital containers;
wherein the first consumer can open the one or more of the plurality of digital containers that were purchased by the first consumer such that the corresponding electronic collectible items and the digital-only collectible items within the one or more of the plurality of digital containers are revealed electronically to the first consumer; and
wherein the first consumer can one of (i) redeem one of the corresponding electronic collectible items within the one or more of the plurality of digital containers, and (ii) pay a fee, to selectively receive one or more of the plurality of physical collectible items that correspond with the corresponding electronic collectible items within the one or more of the plurality of digital containers that the first consumer purchased from the system website and application.
